(19) United States
(12) Patent Application Publication
(10) Pub. No.: US 2010/0082903 A1
(43) Pub. Date: Apr. 1, 2010

(54) NON-VOLATILE SEMICONDUCTOR MEMORY DRIVE, INFORMATION PROCESSING APPARATUS AND DATA ACCESS CONTROL METHOD OF THE NON-VOLATILE SEMICONDUCTOR MEMORY DRIVE

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/426,741

(22) Filed: Apr. 20, 2009

(30) Foreign Application Priority Data
Sep. 30, 2008 (JP) 2008-255199

(51) Int. Cl. G06F 12/08

(52) U.S. Cl. 711/118; 711/E12.017

(57) ABSTRACT

According to one embodiment, a non-volatile semiconductor memory drive stores an address table in a non-volatile semiconductor memory in predetermined units that are storage units of data in the non-volatile semiconductor memory, manages a second address table associating a logical address with a physical address with respect to each part of the address table stored in the non-volatile semiconductor memory, and temporarily stores each part of the address table which has been read in the predetermined units from the non-volatile semiconductor memory in the cache memory based on the second address table.

### CROSS-REFERENCE TO RELATED APPLICATIONS

This application is based upon and claims the benefit of priority from Japanese Patent Application No. 2008-255199, filed Sep. 30, 2008, the entire contents of which are incorporated herein by reference.

### BACKGROUND

1. Field

One embodiment of the present invention relates to a data access control technique of a non-volatile semiconductor memory drive such as a solid-state drive (SSD).

2. Description of the Related Art

In recent years, battery-powered and portable notebook personal computers have become widely used. Many of these kinds of personal computers, which are referred to as mobile notebook PCs, have wireless communication functions, or connect wireless communication modules to universal serial bus (USB) connectors, mount PC card slots, and then, can add the wireless communication functions if necessary. Thus, carrying this kind of mobile notebook PC enables a user to create and transmit a document, and appropriately acquire various items of information even if the user is outside or traveling.

Since this kind of personal computer is required to be highly portable, to be resistant to impact, and to be usable for a long time in a battery-powered state, much research has been performed for miniaturization, for reduction in weight, for increasing impact resistance, and for reducing power consumption. In consideration of the aforementioned circumstances; recently, a mobile notebook PC with an SSD using a flash memory, instead of a hard disk drive (HDD) device, mounted thereon has been produced and commercialized.

Until now, various approaches for schemes to efficiently access data on a storage medium including the flash memory have been proposed (e.g., Jpn. Pat. Appln. KOKAI Publication No. 7-295866).

Meanwhile, the SSD, which is replacing HDD, results in mounting of a flash memory of large capacity (total). Thereby, if the SSD constitutes an address table, which associates a logical address indicating a position in a logical address space of the flash memory (group) with a physical address indicating a position in a physical address space in storage units (i.e., in clusters) of data on the flash memory, the number of entries has to be increased, the capacitance of a RAM has to be increased in order to develop table data in the RAM (mounted on the SSD) as disclosed in Jpn. Pat. Appln. KOKAI Publication No. 7-295866, which results in an increase in costs.

Conversely, if the address table is in larger storage units, while the number of entries is suppressed to a small number, there is a need to write in larger storage units even for a small size of data to be written, and this results in deterioration in data access performance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an exterior appearance of an information processing apparatus (a computer) of an embodiment of the invention;

FIG. 2 is an exemplary view showing a system configuration of the computer of the embodiment;

FIG. 3 is an exemplary block diagram showing a schematic configuration of an SSD to be mounted on the computer of the embodiment as a start drive;

FIG. 4 is an exemplary schematic view showing a schematic configuration of a NAND memory to be installed in the SSD to be mounted on the computer of the embodiment;

FIG. 5 is an exemplary schematic view for explaining a basic algorithm of a data access procedure in the SSD to be mounted on the computer of the embodiment;

FIG. 6 is an exemplary view showing mapping of a logical address space to be formed of the NAND memory of the SSD to be mounted on the computer of the embodiment;

FIG. 7 is an exemplary view showing a procedure of conversion from a logical address specified by a host device of the SSD to be mounted on the computer of the embodiment into a physical address;

FIG. 8 is an exemplary view showing a cluster table (CT) cache directory to be used for caching a part of a read cluster table which is managed by the SSD to be mounted on the computer of the embodiment;

FIG. 9 is an exemplary flowchart showing the flow of data read processing in the SSD to be mounted on the computer of the embodiment; and

FIG. 10 is an exemplary flowchart showing the flow of data write processing in the SSD to be mounted on the computer of the embodiment.

### DETAILED DESCRIPTION

Various embodiments according to the invention will be described hereinafter with reference to the accompanying drawings. In general, according to one embodiment of the invention, a non-volatile semiconductor memory drive stores an address table in a non-volatile semiconductor memory in predetermined units that are storage units of data in the non-volatile semiconductor memory, manages a second address table associating a logical address with a physical address with respect to each part of the address table stored in the non-volatile semiconductor memory, and temporarily stores each part of the address table which has been read in the predetermined units from the non-volatile semiconductor memory in the cache memory based on the second address table.

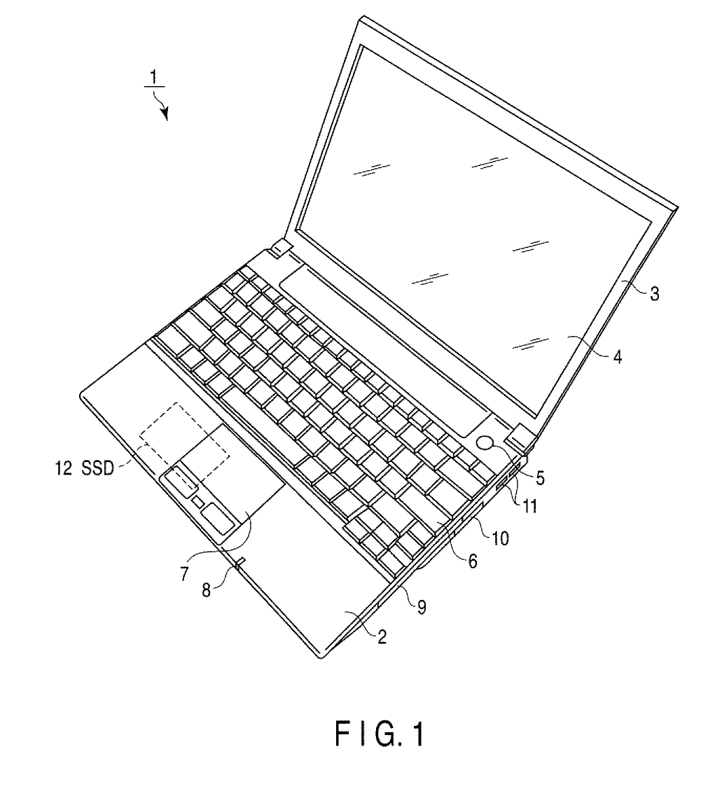

FIG. 1 is an exemplary view showing an exterior appearance of an information processing apparatus of the embodiment. The information processing apparatus is actualized as a battery-powered notebook personal computer 1, called, for example, a mobile notebook PC.

The computer 1 consists of a computer main unit 2 and a display unit 3. A display device composed of a liquid crystal display (LCD) 4 is built into the display unit 3.

The display unit 3 is attached so as to freely rotate between an opening position, in which the upper surface of the computer main unit 2 is exposed, and a closed position covering the upper surface of the computer main unit 2. The computer main unit 2 has a housing of a thin box-shape, and a power switch 5, a keyboard 6, touchpad 7, etc., are arranged on the upper surface of the computer main unit 2.

Light emitting diode (LED) 8 is arranged on the upper surface of the computer main body 2, and an optical disc drive (ODD) 9 capable of writing and reading data to and from a digital versatile Disc (DVD) is arranged on the right surface of the computer body 2. A PC card slot 10 freely removably storing a PC card therein, a USB connector 11 connecting USB equipment, etc., are also arranged on the right surface of the computer body 2. The computer 1 mounts an SSD 12 that is a non-volatile semiconductor memory drive inside the computer main unit 2 as an external storage device to be operated as a start drive.

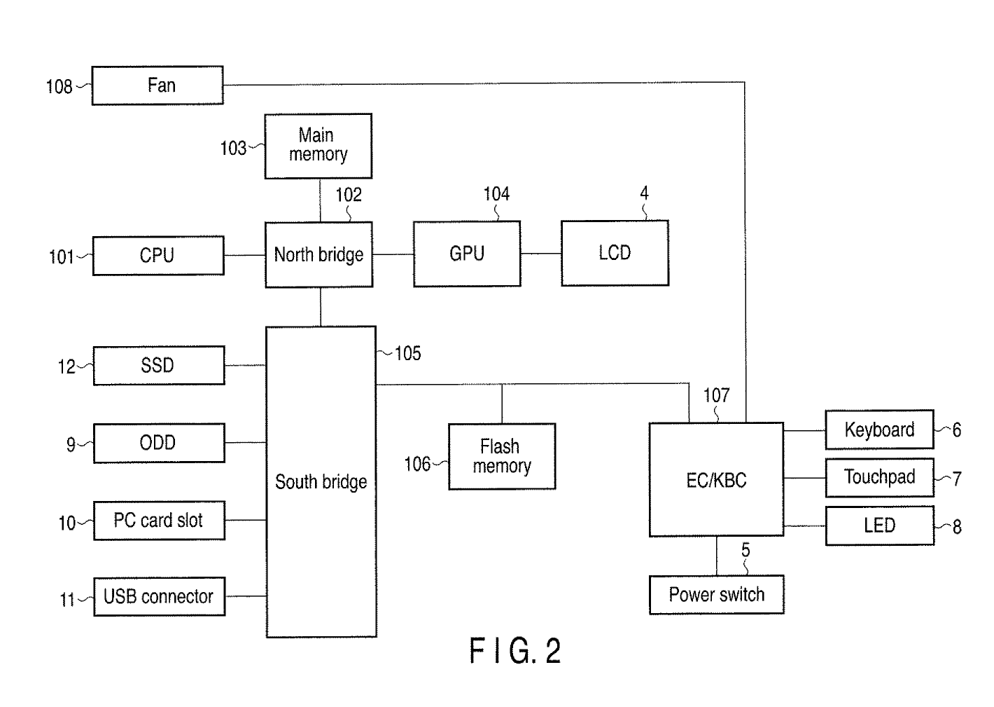

FIG. 2 is an exemplary view showing the system configuration of the computer 1.

The computer 1, as shown in FIG. 2, includes a CPU 101, a north bridge 102, a main memory 103, a graphic controller/keyboard controller (EC/KBC) 107, a fan 108, etc., in addition to the aforementioned LCD4, power switch 5, keyboard 6, touchpad 7, LED 8, the ODD 9, PC card slot 10, USB connector 11 and SSD 12.

The CPU 101 is a processor controlling operations of the computer 1, and executes an operating system and various application programs including utilities, which are loaded from the SSD 12 to the main memory 103. The CPU 101 also executes a Basic Input/Output System (BIOS) stored in the flash memory 106. The BIOS is a program for controlling hardware.

The north bridge 102 is a bridge device connecting the local bus of the CPU 101 and the south bridge 105. The north bridge 102 includes a function of performing communications with the GPU 104 through a bus, and includes a built-in memory controller controlling access to the main memory 103. The CPU 104 controls the LCD 4 to be used as the display device of the computer 1.

The south bridge 105 is a controller which controls various devices such as an SSD 12, ODD 9, PC card stored in the PC card slot 10, USB apparatus connected to the USB connector 11, and flash memory 106.

The EC/KBC 107 is a one-chip microcomputer with a built-in controller for power management, and a keyboard controller for controlling the keyboard 6 and the touchpad 7 are integrated therein. The EC/KBC 107 controls the LED 8 and the fan 108 for cooling.

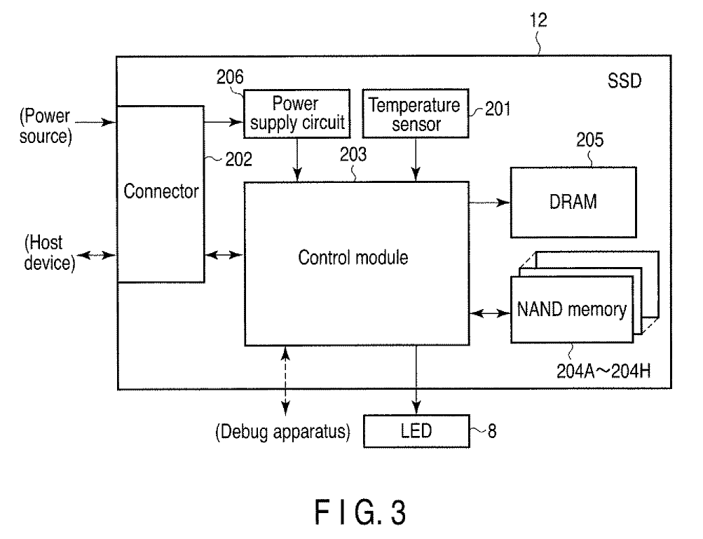

FIG. 3 is an exemplary block diagram showing a schematic configuration of the SSD 12 to be mounted as an external storage device which operates as the start drive of the computer 1 having the system configuration of the above.

As shown in FIG. 3, the SSD 12 consists of a temperature sensor 201, a connector 202, a control module 203, NAND memories 204A-204H, a DRAM 205, a power supply circuit 206, etc. The SSD 12 is a non-volatile external storage device of which the storage data including programs in the NAND memories 204A-204H are not lost even if the power is turned off. The SSD 12 is an external storage device which does not have a drive mechanism such as a disc and a head like an HDD, is resistant to impact, and reduces power consumption.

The control module 203, which controls writing and reading data to and from the NAND memories 204A-204H, as a memory controller is connected to the connector 202, the NAND memories 204A-204H, the DRAM 205 and the power supply circuit 206, respectively. When the SSD 12 is built into the computer main unit 2, the control module 203 is connected to a host device, namely, the south bridge 105 of the computer main unit 2 through the connector 202. If the SSD 12 exists alone, the control module 203 may be connected to debug equipment through, for example, a serial interface of RS-232C standards if necessary.

Each of the NAND memories 204A-204H is, for example, a non-volatile memory including 16 Gbytes of storage capacitance, and for example, a multi level cell (MLC)-NAND memory (multi-value NAND memory) recordable two bits in one memory cell. In comparison with a single level cell (SLC)-NAND memory, the MLC-NAND memory is generally inferior in the number of rewritable times, but its storage capacitance may be easily increased.

The DRAM 205 is a memory device for the use of a cache memory in which the data is temporarily stored for writing and reading the data to and from the NAND memories 204A-204H by means of the control module 203. The power supply circuit 206 generates and supplies the power for operating the control module 203 by utilizing the power supplied from the EC/KBC 107 through the south bridge 105 via the connector 202.

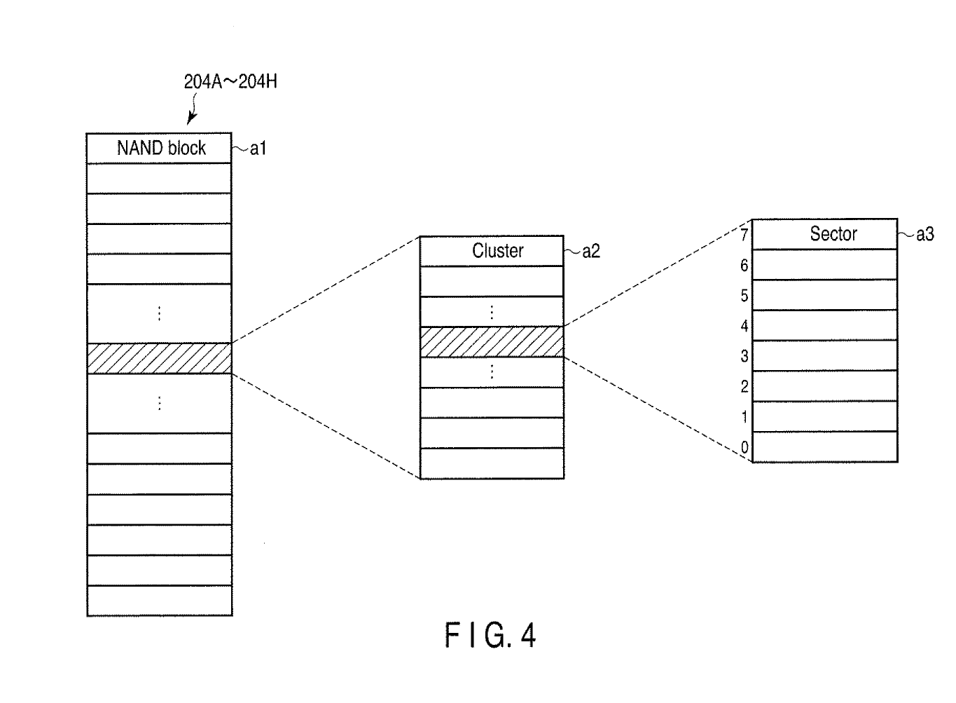

FIG. 4 is an exemplary schematic view showing the schematic configuration of the NAND memories 204A-204H disposed on the SSD 12.

Each of the NAND memories 204A-204H is composed of a plurality of NAND blocks “a1”. The NAND block “a1” consists of 256 clusters “a2”. The data including the program is stored in each of the NAND memories 204A-204H in clusters “a2”. The cluster “a2” is composed of eight sectors “a3”, each of which has a storage capacitance, for example, of 512 bytes. In the SSD 12, a NAND group is composed for each prescribed number of NAND block “a1”.

The control module 203 which controls the data access to the physical address space formed of the NAND memories 204A-204H each having such a schematic configuration receives a data access request from a host device side to be connected via the connector 202 through the specifications of the logical addresses indicating the positions in the logical address space. To receive the specifications, the control module 203 manages an address table associating the logical addresses indicating the positions in the logical address space with the physical addresses indicating the positions in the physical address space. Here, the address table is refereed to as a cluster table (CT).

As mentioned above, the data is stored in the NAND memories 204A-204H in clusters “a2”. Therefore, in consideration of the performance in data writing, it is preferable to construct the cluster table in clusters “a2”. However, if the cluster table is constituted in such a way, the number of entries increases, there is a need to increase the capacity of the DRAM 205 in which the table data is developed, and the costs are increased. Meanwhile, if the cluster table is constituted, for example, in NAND blocks “a1” which are larger than the clusters “a2”, the number of entries is decreased; however, since the data is written in NAND block “a1” even for data writing by several numbers of the clusters “a2”, the access performance of the data is deteriorated. The SSD 12 has a scheme of suppressing an increase in capacity of the DRAM 205 while constituting the cluster table in clusters “a2”, and the following will described this point in detail.

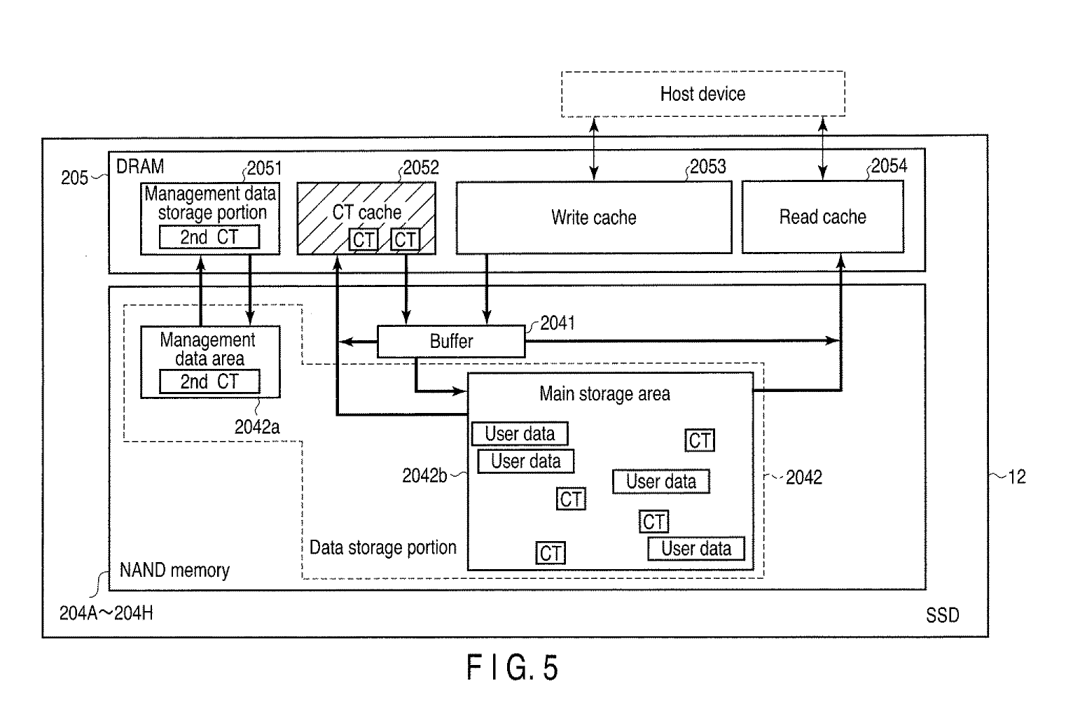

FIG. 5 is an exemplary a schematic view for explaining a basic algorithm of a data access procedure in the SSD 12.

As shown in FIG. 5, the DRAM 205 to be used as a cache memory includes a management data storage portion 2015, a CT cache 2052, a write cache 2053 and a read cache 2054. Each of the NAND memories 204A-204H includes a buffer 2041 and a data storage portion 2042.

Usually, the cluster table is stored in an area separately secured in each of the NAND memories 204A-204H individually from user data. The cluster table is developed on the DRAM 205, the logical addresses specified by the host device are converted into the physical addresses by using the cluster table on the DRAM 205, and data access to the NAND memories 204A-20H is executed. Therefore, as described above, a trade-off relationship in which any of an increase in costs and deterioration in data access performance should be accepted is posed.

Meanwhile, in the SSD 12, the cluster table is constituted in clusters “a2”, and the SSD 12 writes the data in the physical address space formed of the NAND memories 204A-204H in clusters “a2” (by giving the logical addresses) in the same way as that of the user data to store the data in the physical address space. A second cluster table (a 2nd CT) manages the correspondence among the logical addresses given to the cluster table and physical addresses indicating the storage positions of the respective parts of the cluster tables scattered in the physical address space in clusters “a2”. A management data area 2042a and a main storage area 2042b are secured in the management data area 2042 of each NAND memory 204A-204H, and the second cluster table is stored in a management data area 2042a other than the main storage area 2042b in which the user data and the cluster tables are stored therein.

Thereby, the SSD 12, as a general rule, develops the second cluster table in the manage data storage portion 2015 of the DRAM 205, firstly, (i) obtains, by using the second cluster table on the storage portion 2015, the physical addresses indicating the storage positions of the corresponding part of the cluster tables which convert the logical addresses specified by the host device into the physical addresses and reads the corresponding part, and then, (ii) converts, by using the corresponding part of the read cluster table, the logical addresses specified by the host device into the physical addresses and executes the data access to the NAND memories 204A-204H.

According to this data access procedure, since it is sufficient for the second cluster table, which records presence information of the cluster table in clusters, to be developed on the management data storage portion 2015 of the DRAM 205, the increase in capacity of the DRAM 205 may be suppressed first of all.

As mentioned above, in the SSD 12, the CT cache 2052 is provided for the DRAM 205. By using an existing cache technique, the SSD 12 controls so that each of the parts of the cluster table which has been read by using the second cluster table is temporarily stored in the CT cache 2052. The personal computer 1, which is mainly used by an individual, mostly performs data access to the external storage device for the continuous areas in the logical address space. Therefore, even if the following two stages (i), (ii) of data access are executed in principle: (i) data access to the NAND memories 204A-204H (for acquiring the corresponding part of the cluster table) by using the second cluster table; (ii) data access to the NAND memories 204A-204H (for the required data access) by using the cluster table, since most accesses may be performed by using the corresponding part of the cluster table temporarily stored in the CT cache 2052, the SSD 12 can, secondly, suppress any deterioration in the data access performance. Further, the improvement in access performance is achieved in comparison with a case in which the cluster table is constituted in units larger than the cluster “a2”.

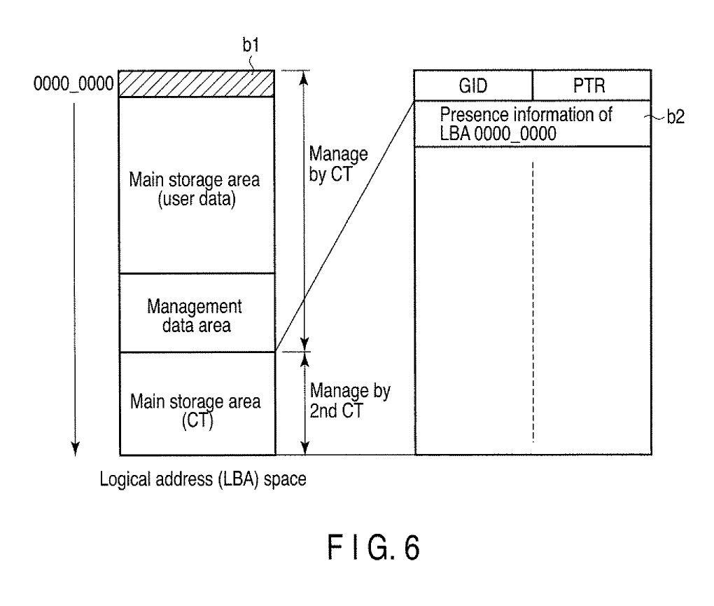

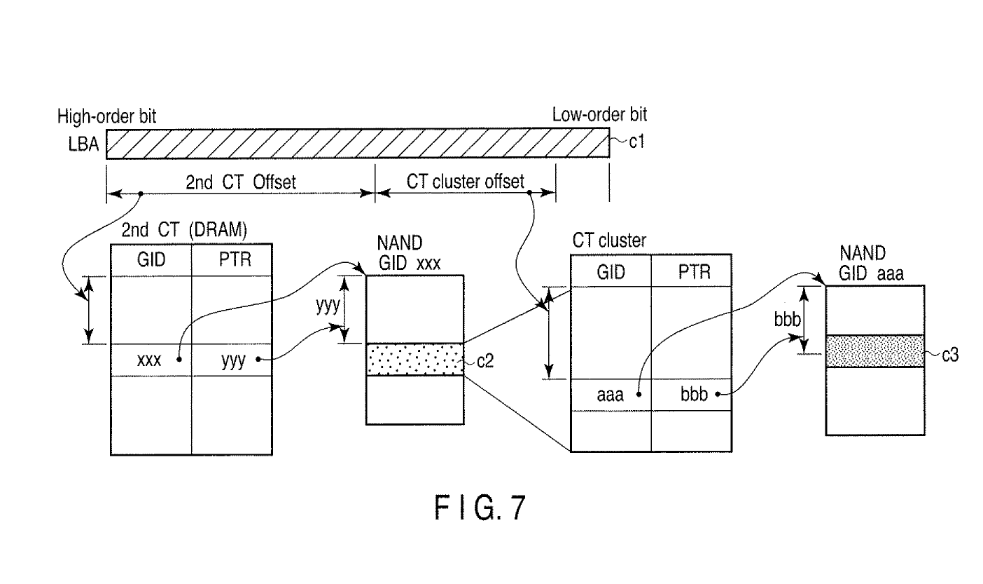

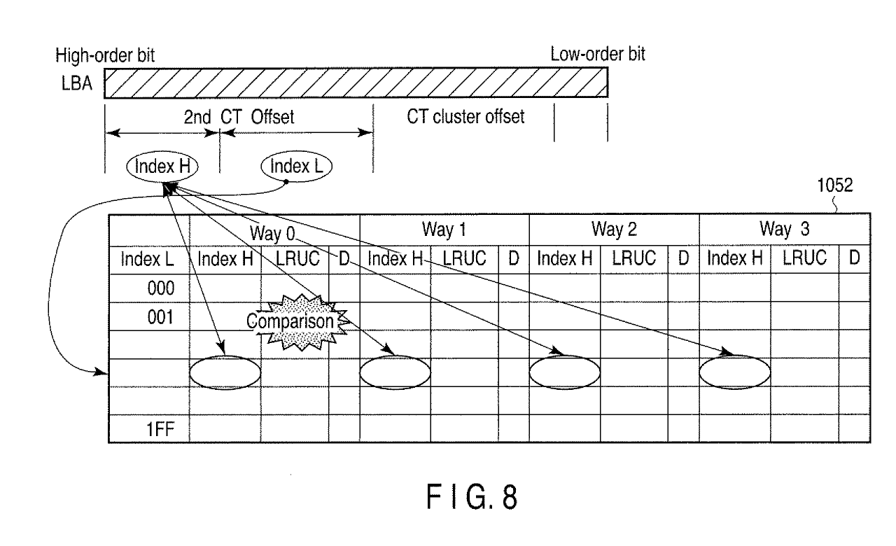

The following will describe the basic algorithm of the data access procedure in the SSD 12, which has been schematically described with reference to FIG. 5 as described above, in detail by referring to FIG. 6, FIG. 7 and FIG. 8.

FIG. 6 is an exemplary view showing mapping of a logical address space to be formed of the NAND memories 204A-204H of the SSD 12.

As shown in FIG. 6, areas for user data in the main storage area 2042b to be secured in each of the NAND memories 204A-204H are firstly assigned in the logical address space formed of the NAND memories 204A-204H. The SSD 12 accepts the data access request from the host device within the assigned range.

Next, the management data area 2042a to be secured in the data storage portion 2042 of each of the NAND memories 204A-204Ha is assigned in the logical address space, and further, areas for the cluster tables (CTs) are assigned in the main storage area 2042b to be secured in the data storage portion 2042 in the NAND memories 204A-204H.

As mentioned above, assigning those areas to the logic address space enables the cluster table to manage the correspondence relationships among the user data areas in main storage area 2042b and the logical addresses and the physical addresses in the user data areas in the management data area 2042a, and enables the second cluster table to manage the correspondence relationships among the logical addresses and the physical addresses indicating the storage positions in the main storage area 2042b of the cluster table.

For instance, if it is assumed that the host device requires data access to a logical address “0000_{—}0000” (“b1”), the control module 203 firstly obtains, by using the second cluster table on the DRAM 205, the physical addresses indicating the storage positions on the NAND memories 204A-204H of the corresponding parts (“b2”) of the cluster tables which record presence information (management information including physical addresses) of the logical address “0000_{—}0000”. The control module 203 then executes the required data access to the physical addresses included in the corresponding parts (“b2”) of the cluster tables read through the obtained physical addresses.

FIG. 7 is an exemplary view showing a procedure of conversion from a logical address specified by the host device into the physical address.

As described above, in the SSD 12, a NAND group is constituted for each prescribed number of NAND block “a1”. Thus, the physical address may be treated as an identifier (GID) of the NAND group+a pointer (PTR) in the NAND group. Thereby, in the SSD 12, each entry to the cluster table and the second cluster table are composed of the identifier (GID) of the NAND group+the pointer (PTR) in the NAND group.

The control module 203 firstly searches the second address table by using a value, as a retrieval key, of a bit row (2nd CT Offset) from the most significant bit in a bit row (“c1”) indicating the logical addresses specified by the host device up to the position corresponding to a logical address width to be recorded in each part of the cluster table divided in each cluster, and reads a part (“c2”) of a target cluster table from a physical address (GID+PTR) obtained from the second cluster table.

The control module 203 then searches the part of the previously read cluster table by using the value, as a retrieval key, of the bit row (CT cluster Offset) which follows the 2nd CT Offset and in which each part of the cluster table divided into each cluster continues up to a position corresponding to the cluster number in which address information is recorded, and obtains a physical address (“C3”) corresponding to the logical address specified by the host device from the part of the previously read cluster table.

FIG. 8 is an exemplary view showing a CT cache directory to be used for temporarily caching a part of the cluster table which has been read in the aforementioned procedure in the CT cache 2052 disposed in the DRAM 205.

The control module 203 forms bit rows in which the values of a low-order n-bit row (Index L) of the foregoing 2nd CT Offset coincide with each other as one group, and controls so that each part of the cluster table is temporarily stored in the CT cache 2052 for every four parts for each group. Therefore, the control module 203 manages the CT cache directory shown in FIG. 8.

Each “LRUC” in the CT cache directory is a counter area for recording the last times parts of the cluster table were used. Each “D” is a flag area (Dirty bit) for recording the fact of a case where data in any cluster which has been recorded in the part of the cluster is updated.

Upon reception of the data access request from the host device, the control module 203 checks whether or not each value of a high-order m-bit row (Index H) of the foregoing 2nd CT Offset of the CT cache directory is present in four groups by using the value of the foregoing Index L in the bit row indicating the specified logical addresses. If the value is present therein, it shows that the part of the target cluster table is stored in the CT cache 2052, and the control module 203 uses the corresponding part in the cluster table stored in the CT cache 2052 to convert the specified logical address into the physical address. At this time, the value of the “LRUC” is counted up at the newest time, and if the data access involves an update of the data, the Dirty bit turns on.

Conversely, if the value is not present therein, since the part of the target cluster table is not stored in the CT cache 2052, while the control module 203 reads the values from the NAND memories 204A-204H in the aforementioned procedure, at this moment, the control module 203 determines which part of the cluster table has not been used most recently in the group (coinciding the values of the Index L with one another) on the basis of the value of the “LRUC”, and stored the newly read part of the cluster table in the CT cache 2052 by replacing the determined part of the cluster table which has not been used most recently with the newly read part of the cluster table. Further, at this moment, if the Dirty bit of the determined part of the cluster table which has not been used most recently is turned on, the control module 203 disables the storage position of the part of the cluster table (one generation previous) which is presently shown in the second cluster table, newly writes the determined parts of the cluster table stored in the CT cache 2052 in the NAND memories 204A-204H, and updates presence information on the second cluster table concerning the determined parts of the cluster table.

In this way, using the CT cache directory and controlling caching of each part of the cluster table to be stored in the NAND memories 204A-204H in clusters “a2” by means of the CT cache disposed on the DRAM 205 achieves an improvement in access performance.

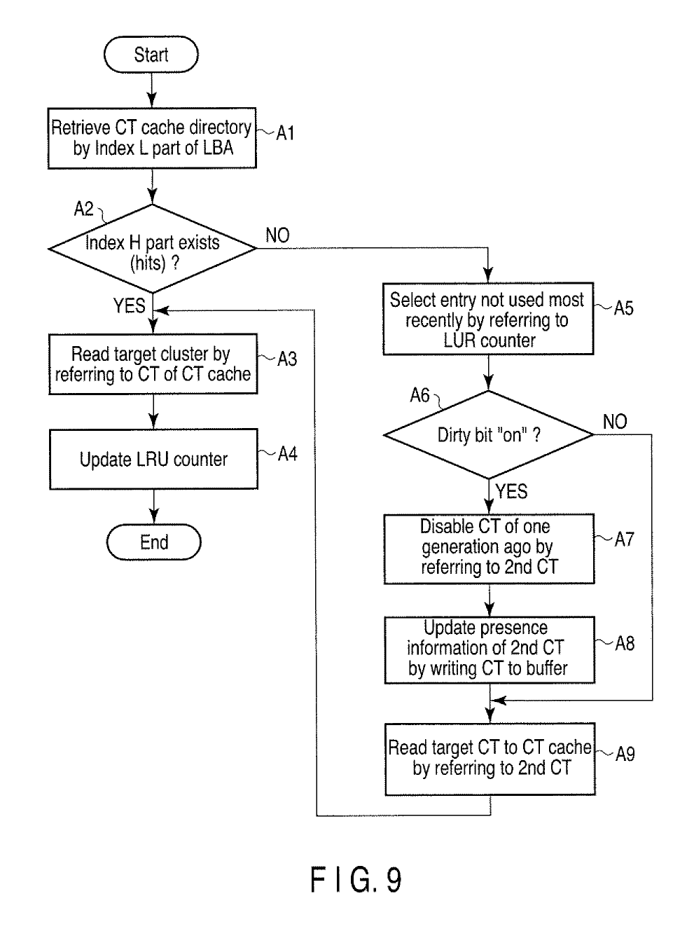

FIG. 9 is an exemplary flowchart showing the flow of data read processing in the SSD 12.

The control module 203 searches the CT cache directory by using the value of the Index L, as a retrieval key, that is a bit row in the 2nd CT Offset that is a bit row at the upper part in the bit row indicating the logical address specified from the host device and the bit row at the lower part in the 2nd CT Offset (Block A1). If the value of an Index H part that is a bit row in the 2nd CT Offset and that is a bit row at an upper part in the 2nd CT Offset has been detected in the CT cache directory (YES in Block A2), since the corresponding part of the cluster table needed to convert the logic address specified by the host device into the physical address is stored in the CT cache 2052, the control module 203 obtains the physical address by using the corresponding part of the cluster table stored in the CT cache 2052, and executes data read from the target cluster in the NAND memories 204A-204H (Block A3). The control module 203 then updates the value of the “LRUC” of the CT cache directory concerning the corresponding part of the cluster table stored in the CT cache directory with the value of the current time (Block A4).

Conversely, if the value of the Index H part has not been detected from the CT cache directory (NO in Block A2), the control module 203 selects an entry on which the “LRUC” indicates the oldest past time (Block A5), and checks whether or not the Dirty bit of the selected entry has been turned on (Block A6). If the Dirty bit has been turned on (YES in Block A6), the control module 203 disables the corresponding part of the cluster table in the one generation previous by using the second cluster table (Block A7), writes the corresponding part of the cluster table stored in the CT cache 2052 in the buffer 2041, and updates the presence information on the second cluster table (Block AB).

The control module 203 which has secured one empty entry in the CT cache directory refers to the second cluster table, and reads the corresponding part of the target cluster table (Block A9). Since the corresponding part of the read cluster table is stored in the CT cache 2052, the control module 203 executes the target data read in the procedures of blocks A3-A4.

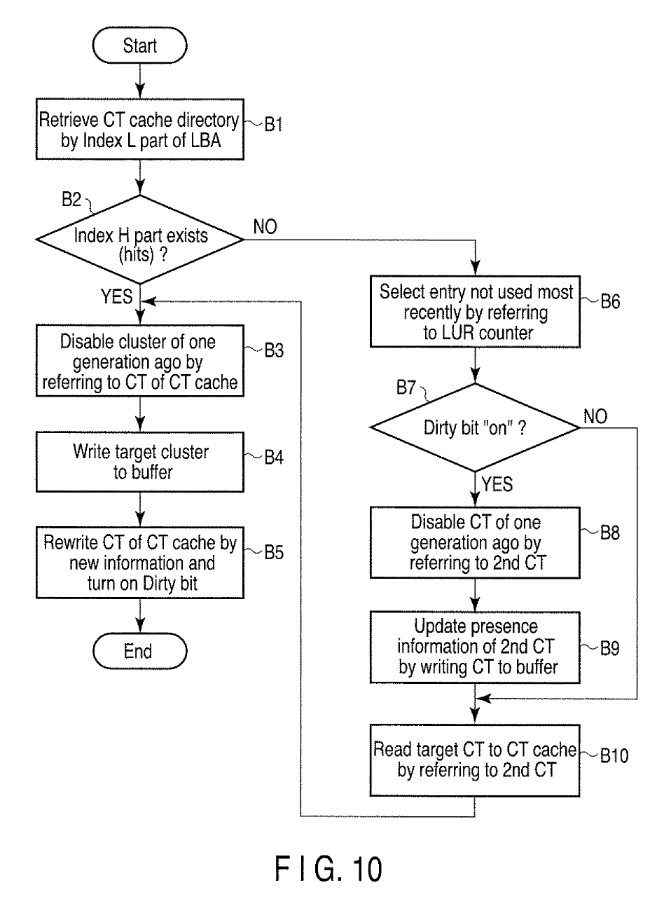

FIG. 10 is an exemplary flowchart showing the flow of data write processing in the SSD 12.

The control module 203 searches the CT cache directory by using the value, as a retrieval key, of the Index L part that is a bit row in the 2nd CT Offset that is a bit row at the upper part in the bit row indicating the logical address specified by the host device and that is a bit row at the lower part of the 2nd CT Offset (Block B1). If the value of the Index H part that is the bit row in the 2nd CT Offset and that is the bit row at the upper part in the 2nd CT Offset has been detected in the CT cache directory (YES in Block B2), the corresponding part of the cluster table needed to convert the logical address specified by the host device into the physical address has been stored in the CT cache 2052.

The control module 203 firstly disables the cluster of one generation previous (user data recorded therein) by using the corresponding part of the cluster table stored in the CT cache 2052 (Block B3). Then, the control module 203 writes the cluster (recording user data including write data) in the buffer 2041 to execute the target data writing (Block B4). The control module 203 rewrites the corresponding part in the cluster table stored in the CT cache 2052 into new information (the rewriting records the value of the current time in the “LRUC” of the CT cache directory concerning the corresponding part of the cluster table), and turns on the Dirty bit of the CT cache directory concerning the corresponding part of the cluster table (Block B5).

Conversely, if the value of the Index H part has not been detected in the CT cache directory (NO in Block B2), the control module 203 selects the entry of which the “LRUC” indicates the oldest past time (Block B6), and checks whether or not the Dirty bit of the selected entry has been turned on (Block B7). If the Dirty bit has been turned on (YES in Block B7), the control module 203 refers to the second cluster table and disables the corresponding part of the cluster table of one generation previous (Block B8), and writes the corresponding part of the cluster table stored in the CT cache 2052 to update the presence information on the second cluster table (Block B9).

The control module 203 which secures one empty entry for the CT cache directory refers to the second cluster table, and reads the corresponding part of the target cluster table (Block B10). Since the corresponding part of the read cluster table is stored in the CT cache 2052, the control module 203 executes the target data writing in the procedures of blocks B3-B5.

As mentioned above, the computer 1 with the SSD 12 mounted thereon achieves both an improvement in the data access performance and suppression of increase in the costs for a non-volatile semiconductor memory with a large capacity.

While the foregoing embodiment has described an example in which the caching of each part of the cluster table by means of the CT cache 2052 is performed in a so-called 4 Way set associative system as shown in FIG. 8, the invention is not limited to the example. For instance, it is possible to apply a so-called full associative system in which each part of any of the cluster table may be stored in an arbitrary cache line in a plurality of cache lines secured on the CT cache 2052, and the logical address of each part of the cluster table is managed as tag information for each of the plurality of cache lines.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A non-volatile semiconductor memory drive comprising:
a non-volatile semiconductor memory;
a cache memory; and
a controller which manages an address table associating a logical address indicating a position in a logical address space with a physical address indicating a position in a physical address space of the non-volatile semiconductor memory, receives a data access request to the non-volatile semiconductor memory to be issued by specifying the logical address, and controls writing and reading of data to and from the non-volatile semiconductor memory,
the controller including:
an address table storage module configured to store the address table in the non-volatile semiconductor memory in predetermined units which are storage units of the data in the non-volatile semiconductor memory;
a second address table management module configured to manage a second address table associating a logical address with a physical address with respect to each part of the address table stored in the non-volatile semiconductor memory by the address table storage module;
an address table cache module configured to temporarily store each part of the address table which has been read in the predetermined units from the non-volatile semiconductor memory in the cache memory based on the second address table to be managed by the second address table management module; and
an address conversion module configured to:
(i) determine whether or not the corresponding part of the address table in which information related to the logical address specified by the data access request has been temporarily stored in the cache memory by the address table cache module,
(ii) acquire, when the corresponding part of the address table has been temporarily stored in the cache memory, a physical address associated with the logical address specified by the data access request by referring to the corresponding part of the address table temporarily stored in the cache memory, and
(iii) acquire, when the corresponding part of the address table has not been temporarily stored in the cache memory, a physical address indicating a storage position of the corresponding part of the address table by referring to the second address table to be managed by the second address table management module, read the corresponding part of the address table from the non-volatile semiconductor memory based on the acquired physical address, and acquire the physical address associated with the logical address specified by the data access request by referring to the read corresponding part of the address table.

2. The non-volatile semiconductor memory drive of claim 1, wherein the address table is constituted so as to record correspondence relations between the logical address and the physical address in the predetermined units.

3. The non-volatile semiconductor memory drive of claim 1, wherein:
the non-volatile semiconductor memory drive is defined a first area configured to be specified when the data access request is issued and a second area configured not to be specified when the data access request is issued in the logical address space of the non-volatile memory; and
the address table storage module assigns the address table to the second area of the logical address space to write the address table in the non-volatile semiconductor memory.

4. The non-volatile semiconductor memory drive of claim 1, wherein the address table cache module controls so as to form a group of logical addresses of which the values of bit rows positioned in a predetermined range in a bit row indicating logical addresses to be specified by the data access request coincide with each others and to temporarily store each part of the address table in the cache memory in predetermined numbers for each group.

5. The non-volatile semiconductor memory drive of claim 1, wherein:
the address table cache module divides an area to be secured on the cache memory in order to temporarily store each part of the address table into sizes able to be stored in predetermined numbers of each part of the address table, and manages, as tag information, a logical address indicating a storage position of each stored part of the address table for each divided area; and
the address conversion module determines whether or not the corresponding part of the address table in which the information related to the logical address specified by the data access request is recorded has been temporarily stored in the cache memory by referring to the tag information.

6. An information processing apparatus comprising:
a main apparatus; and
a non-volatile semiconductor memory drive including a non-volatile semiconductor memory,
the main apparatus including a data access request module configured to issue a data access request to the non-volatile semiconductor memory to the non-volatile semiconductor memory drive device by specifying a logical address indicating a position in a logical address space of the non-volatile semiconductor memory, and
the nonvolatile semiconductor memory drive including:
a cache memory;
an address table storage module configured to store an address table associating the logical address indicating the position in the logical address space with a physical address indicating a position in a physical address space of the non-volatile memory in the non-volatile semiconductor memory in predetermined units that are storage units of data in the non-volatile semiconductor memory;
a second address table management module configured to manage a second address table associating a logical address with a physical address with respect to each part of the address table stored in the non-volatile semiconductor memory by the address table storage module;
an address table cache module configured to temporarily store each part of the address table which has been read in the predetermined units from the non-volatile semiconductor memory in the cache memory based on the second address table to be managed by the second address table management module; and
an address conversion module configured to:
(i) determine whether or not the corresponding part of the address table in which information related to the logical address specified by the data access request from the main apparatus has been temporarily stored in the cache memory by the address table cache module;
(ii) acquire, when the corresponding part of the address table has been temporarily stored in the cache memory, a physical address associated with the logical address specified by the data access request by referring to the corresponding part of the address table temporarily stored in the cache memory, and
(iii) acquire, when the corresponding part of the address table has not been temporarily stored in the cache memory, a physical address indicating the storage position of the corresponding part of the address table by referring to the second address table to be managed by the second address table management module, read the corresponding part of the address table from the non-volatile semiconductor memory, and acquire the physical address associated with the logical address specified by the data access request by referring to the read corresponding part of the address table.

7. A data access control method of a non-volatile semiconductor memory drive including a non-volatile semiconductor memory, a cache memory, and a controller which manages an address table associating a logical address indicating a position in a logical address space with a physical address indicating a position in a physical address space of the non-volatile semiconductor memory, receives a data access request to the non-volatile semiconductor memory to be issued by specifying the logical address, and controls writing and reading of data to and from the non-volatile semiconductor memory, the method comprising:
storing the address table in the non-volatile semiconductor memory in predetermined units that are storage units of data in the non-volatile semiconductor memory;
managing a second address table associating a logical address with a physical address with respect to each part of the address table stored in the non-volatile semiconductor memory;
temporarily storing each part of the address table which has been read in the predetermined units from the non-volatile semiconductor memory in the cache memory based on the second address table;
determining whether or not the corresponding part of the address table in which information related to the logical address specified by the data access request has been temporarily stored in the cache memory;
acquiring, when the corresponding part of the address table has been temporarily stored in the cache memory, a physical address associated with the logical address specified by the data access request by referring to the corresponding part of the address table temporarily stored in the cache memory; and
acquiring, when the corresponding part of the address table has not been temporarily stored in the cache memory, a physical address indicating a storage position of the corresponding part of the address table by referring to the managed second address table, reading the corresponding part of the address table from the non-volatile semiconductor memory based on the acquired physical address, and acquiring the physical address associated with the logical address specified by the data access request by referring to the read corresponding part of the address table.
